(19) United States
(12) Patent Application Publication
(10) Pub. No.: US 2002/0103008 A1
(43) Pub. Date: Aug. 1, 2002

(54) Cordless communication between PDA and host computer using cradle

(76) Inventors: Michael D. Rahn, Rochester, MN (US); David B. Lection, Raleigh, NC (US)

Correspondence Address: Esther H. Chong, Esquire, Synnestvedt & Lechner LLP, 2600 Aramark Tower, 1101 Market Street, Philadelphia, PA, 19107-2950, US

(21) Appl. No.: 09/772,455

(22) Filed: Jan. 29, 2001

(51) Int. Cl. H04M 1/00

(52) U.S. Cl. 455/557; 455/556; 455/66; 455/74

(57) ABSTRACT

A docking device, also known as a cradle, used in docking a PDA (personal digital assistant) for data synchronization with a host computer, includes an antenna for providing cordless communication between the PDA and the host computer. The cordless communication is established without docking the PDA in the cradle and without the use of a wireless network or carrier. Thus, both economical and convenient data communication can be performed between the PDA and the host computer using the cradle.

### BACKGROUND OF THE INVENTION

1. Field of the Invention

The present invention relates to communication between computer devices and, more particularly, to a method and system of communicating between a personal digital assistant (PDA) and a host computer without docking the PDA in a cradle.

2. Description of the Related Art

Personal digital assistants (PDAS) are smart handhelds that provide organizing functions, such as address books, calendars, appointment books, notepads, etc. Any information entered into the PDA can be backed up into a user's PC (Personal Computer) by the use of a small docking device known as the “cradle”.

To back up data from the PDA to the PC or synchronize data between the PDA and the PC, the user inserts or “docks” the PDA into a conventional cradle which is typically wired to a USB/serial port of the host computer. By pressing a synchronization button or other designated button on the cradle, data synchronization between the PDA and the desktop occurs through the cradle. The cradle may also provide capability for recharging the docked PDA for use in remote operations.

Another way for the PDA to communicate with the host computer may be through a wireless carrier or network such as Sprint, Palm, etc. using cellular wireless technology. PDAs with fully integrated wireless capability, such as Palm™ VII Series by Palm, Inc., or add-on devices for attaching to PDAs to provide wireless capability to the PDAs, are known. U.S. Pat. No. 5,974,238 to Chase, Jr., issued on Oct. 26, 1999, which is herein fully incorporated by reference, describes a PDA with fully integrated wireless capabilities for communicating with a host computer through a wireless carrier, local area network (LAN) or other networks.

In the case where the PDA communicates with the host computer by being docked in the cradle, the portability of the PDA is limited during this communication process since the PDA must remain in the cradle. On the other hand, in the case where the PDA may communicate with the host computer through a wireless carrier or network, the use of the wireless carrier or network requires subscription to the wireless carrier or network, adding costs to the user.

Therefore, a need exists for a method and system by which a PDA and a host computer can communicate with each other without the use of a wireless carrier or network or the physical limitation imposed by the conventional docking process.

### SUMMARY OF THE INVENTION

The present invention provides an improved docking device or cradle for use with a PDA (personal digital assistant). The cradle includes an antenna for providing cordless communication between the PDA and a host computer connected to the cradle. The PDA also includes an antenna for communicating with the antenna of the cradle. The present invention uses existing “cordless” spread spectrum radio technology typically used in cordless telephones (with based station and handset) and applies it to a conventional cradle and PDA to provide cordless communication between the host computer and the PDA via the cradle. Thus, without using a wireless carrier/network or cellular wireless technology, or without docking the PDA in the cradle, data communication can be established between the PDA and the host computer through the cradle.

Accordingly, an object of the present invention is to provide a communications method and system which overcomes the problems and disadvantages associated with conventional methods of communicating between a PDA and a host computer.

Another object of the present invention is to provide a cradle having an antenna for providing cordless communication between a PDA and a host computer.

Other objects and advantages of the present invention will be set forth in part in the description and the drawings which follow, and, in part, will be obvious from the description or may be learned by practice of the invention.

### BRIEF DESCRIPTION OF THE DRAWINGS

FIG. 1 shows a pictorial representation of a communications system according to a preferred embodiment of the present invention;

FIG. 2A shows a pictorial representation of a cradle of FIG. 1 according to the present invention;

FIG. 2B shows a functional block diagram of the cradle of FIG. 2A;

FIG. 3A shows a pictorial representation of a PDA of FIG. 1 according to the present invention;

FIG. 3B shows a block diagram of the PDA of FIG. 3A;

FIG. 4 shows a block diagram of a host computer of FIG. 1 according to the present invention;

FIG. 5 shows a block diagram of the system of FIG. 1 for explaining cordless communication according to one embodiment of the present invention; and

FIG. 6 shows a pictorial representation of a communications system according to another embodiment of the present invention.

### DESCRIPTION OF THE PREFERRED EMBODIMENTS

In the present invention, a personal digital assistant (PDA) represents any handheld device providing electronic organizer functions, and may include, but are not limited to, traditional PDA devices such as PalmPilots, as well as non-traditional PDA devices such as telephones with integrated PDA functions. The “cordless communication” referred to herein represents communication between locally disposed devices that are not physically connected to each other, without the use of a network, a wireless carrier or cellular wireless technology; an example of such cordless communication is found in communication between a cordless telephone and its base station using cordless spread spectrum radio technology. The elements with the same reference numerals in the drawings represent the same elements.

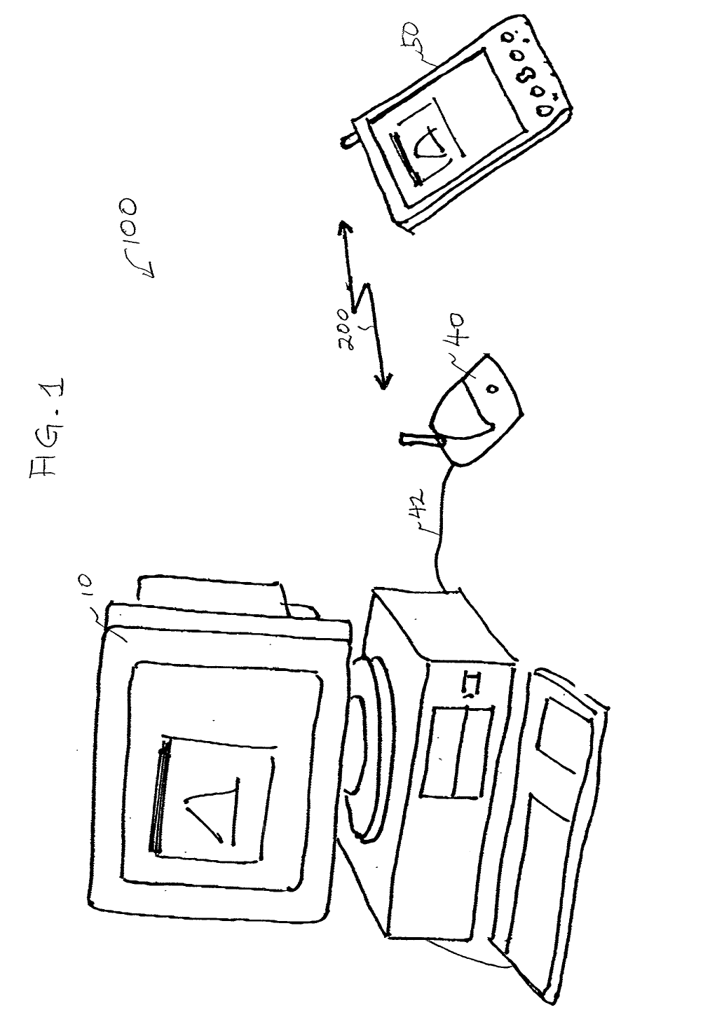

FIG. 1 shows a pictorial representation of a communications system 100 according to a preferred embodiment of the present invention. As illustrated, the communications system 100 includes a host computer 10, a cradle 40 physically connected to the host computer 10 through a wire connection 42, and a PDA 50 cordlessly communicating (200) with the host computer 10 through the cradle 40. These components are all operatively connected. Although it is not illustrated for the sake of clarity, the PDA 50 represents any device capable of providing PDA functions, and is intended to cover an existing PDA installed with a plugin-card or a wrap-around “strap-on” unit providing a radio mechanism outboard of the PDA. In the example of a PDA with the “strap-on” unit, the PDA can still fit into the docking cradle with the “strap-on”unit installed on the PDA.

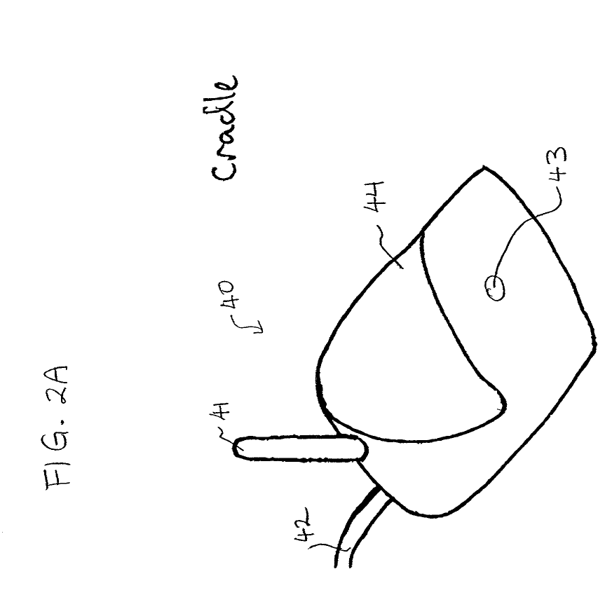

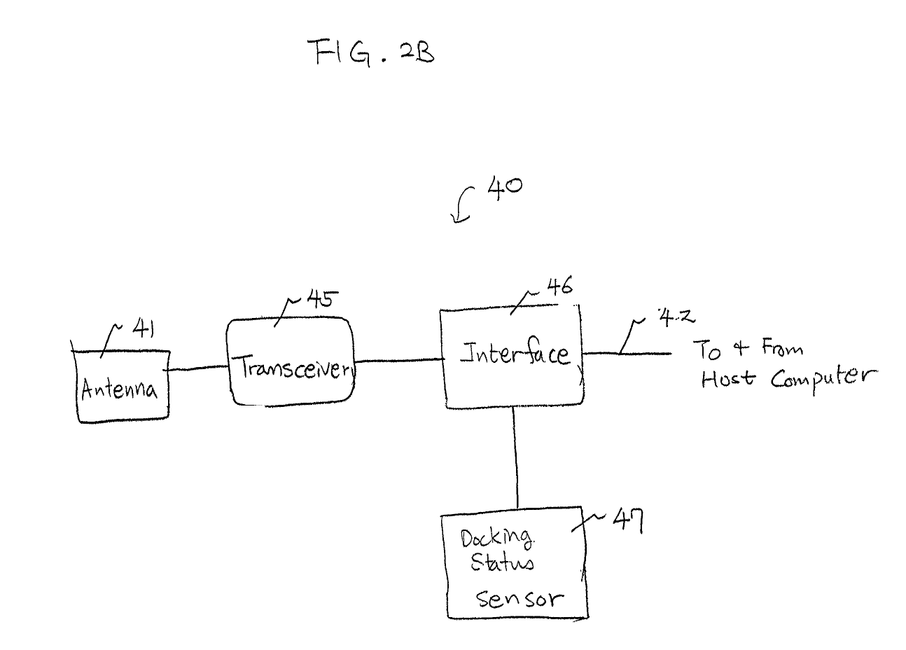

FIG. 2A shows a pictorial representation of the cradle 40 of FIG. 1 and FIG. 2B shows a functional block diagram of the cradle 40 in accordance with the present invention. As shown in FIG. 2A, the cradle 40 includes an antenna 41 for transmitting and receiving radio frequency (RF) signals, the wire connection 42 for physically and electrically connecting the cradle 40 to the host computer 10, a synchronization button 43 for commencing a conventional data synchronization process, and a docking area 44 for receiving the PDA 50 therein, wherein all these components are operatively disposed in the cradle 40. Although one example of the cradle is shown for the sake of brevity, other designs, shapes or configurations are possible for the cradle 40 and such are contemplated as part of the present invention.

FIG. 2B illustrates a functional block diagram of the cradle shown in FIG. 2A. As shown in FIG. 2B, the cradle 40 includes a transceiver 45, an interface 46 and a docking status sensor 47, all operatively coupled. The docking status sensor 47 detects the docking of the PDA 50 in the docking area 44 of the cradle 40. The transceiver 45 receives the RF signal from the antenna 41, performs signal processing (e.g., demodulation) on the RF signal and transmits it to the interface 46. The interface 46 receives the RF signal, converts it into a form (decrypted or decoded data) recognizable by the host computer 46, and transmits it to the host computer 10 through the wire connection 42. The interface 46 also converts data from the host computer 10 into data (encrypted or encoded data) suitable for radio transmission and delivers it to the transceiver 45 which modulates the signal for transmission by the antenna 41. The interface 46 further processes a docking detection signal from the sensor 47 according to known techniques so that the existence of a PDA docked in the cradle 40 can be identified by the host computer.

Although not shown, the cradle 40 may further include any components or circuitry typically found in a conventional cradle, such as a recharging circuit for recharging the docked PDA.

It should be clearly understood that the antenna 41 of the cradle 40 is an antenna typically used in local communication, e..g, in cordless telephones, and may have an operational range in accordance with FCC guidelines for 900 MHz and 2.4 MHz unlicensed radio operation, typically in the range of about 100-300 feet without physical obstruction. The antenna 41 is distinct from cellular antennas typically used in wireless communications for communicating with a wireless carrier or through a network, such as the antennas used in wireless PDAs such as Palm VII Series.

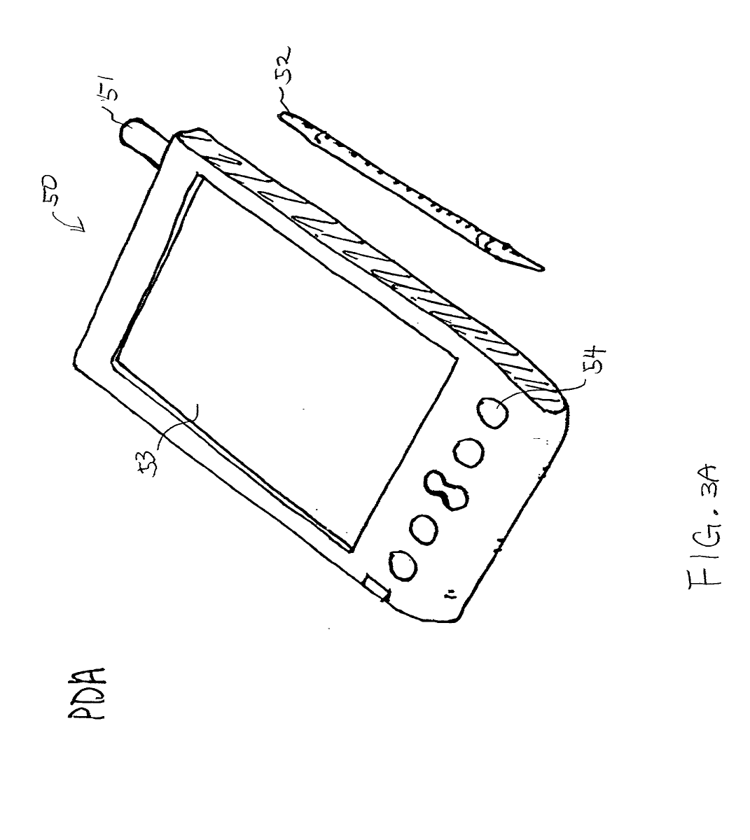

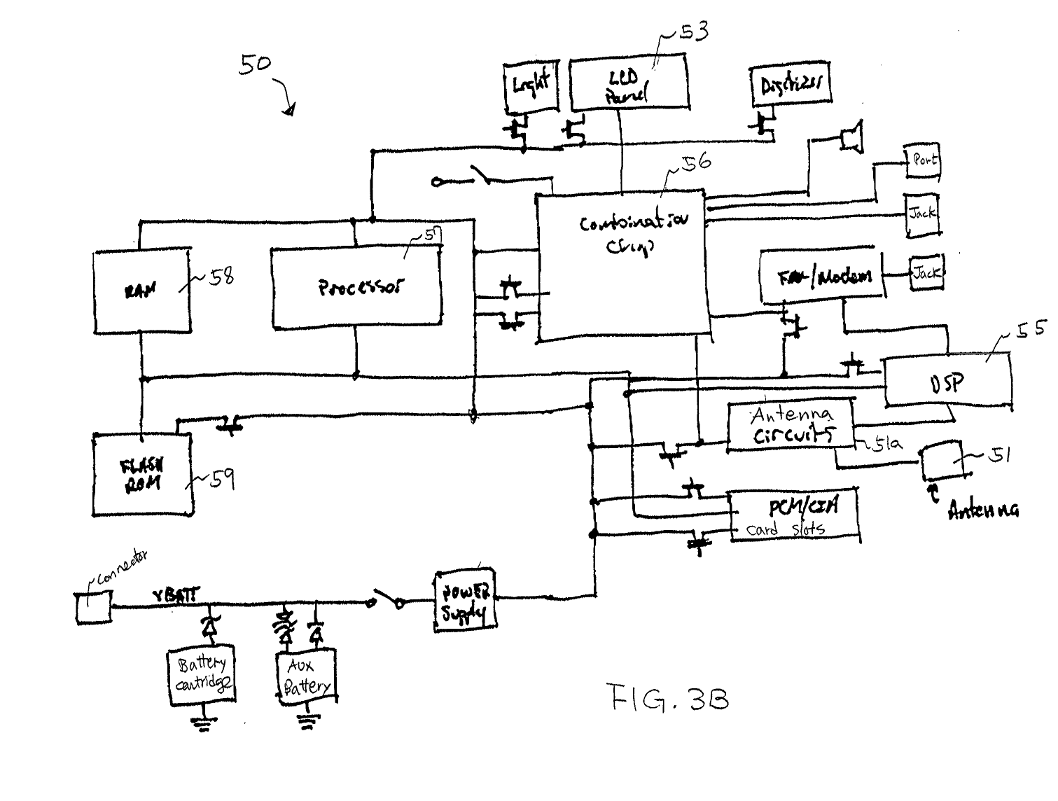

FIG. 3A shows a pictorial representation of the PDA 50 shown in FIG. 1, and FIG. 3B shows a functional block diagram of the PDA 50 in accordance with the present invention. As illustrated in FIGS. 3A and 3B, the PDA 50 includes an antenna 51 which is capable of communicating with the antenna 41 of the cradle 40, antenna circuits 51 a for receiving and transmitting RF signals through the antenna 51, a digital signal processor (DSP) 55 for processing (e.g., modulating or demodulating) the RF signals to and from the antenna circuits 51a, a combination chip 56 for receiving the processed signals from the DSP 55 and performing interface operations to allow cordless communications with the PDA 50, and a microprocessor 57 for executing appropriate programs/applications stored in RAM 58 and/or ROM 59 in cooperation with the logics stored in the combination chip 56. The PDA 50 may further include a stylus 52, an LCD panel 53, input buttons 54, and any other components or circuitry (e.g., PCM/CIA card slots, a power supply, wireless circuits and antenna, add-ons, etc.) found in a conventional PDA such as discussed in U.S. Pat. No. 5,666,530 to Clark et al. issued on Sept. 9, 1997, which is herein fully incorporated by reference.

Similarly to the antenna 41 of the cradle 40, the antenna 51 of the PDA 50 is the type of antenna typically used in local communications, e.g., in cordless telephones, and is clearly distinct from antennas used in wireless PDAs for communicating with a wireless network or carrier according to cellular wireless technology.

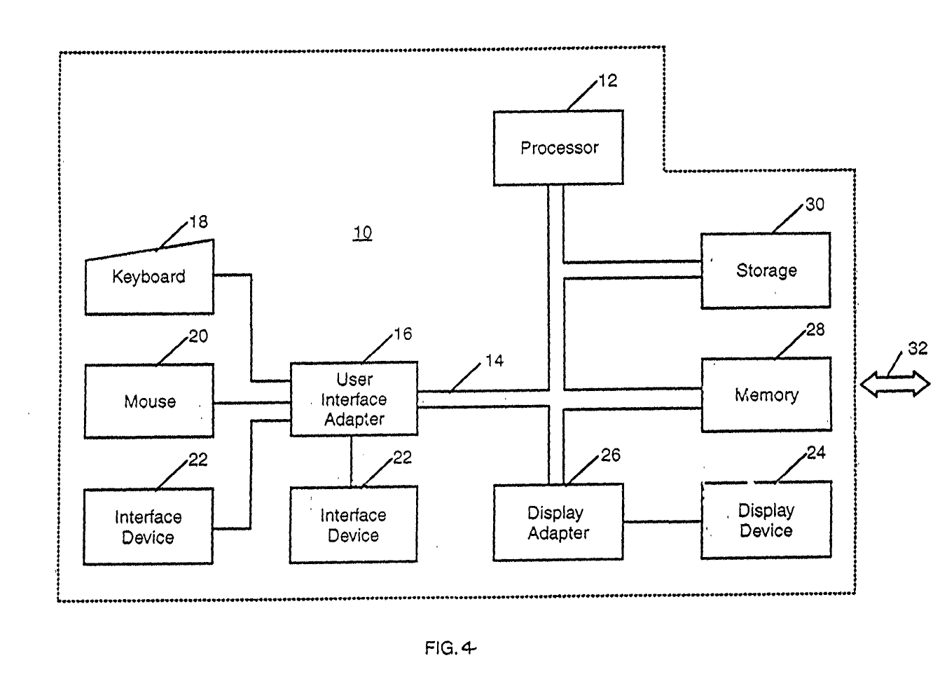

FIG. 4 shows a block diagram of the host computer 10 shown in FIG. 1 according to the present invention. Referring to FIG. 4, the host computer 10 may be a workstation such as a personal computer, including related peripheral devices. The computer 10 includes a microprocessor 12 and a bus 14 employed to connect and enable communication between the microprocessor 12 and the components of the computer 10 in accordance with known techniques. The computer 10 includes a user interface adapter 16, which connects the microprocessor 12 via the bus 14 to one or more interface devices, such as a keyboard 18, a mouse 20, and/or other interface devices 22 such as the cradle 40/PDA 50, a touch sensitive screen, a digitized entry pad, etc. The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

Although it is not necessary for the purpose of the present invention, the computer 10 may be able to communicate with other computers or networks of computers, for example via a communications channel or modem 32. Alternatively, the computer 10 may be able to communicate using a wireless interface at 32, such as a CDPD (cellular digital packet data) card. The computer 10 may be associated with such other computers in a LAN or a wide area network (WAN), or the computer 10 can be a client in a client/server arrangement with another computer, etc. All of these configurations, as well as the appropriate communications hardware and software, are known in the art.

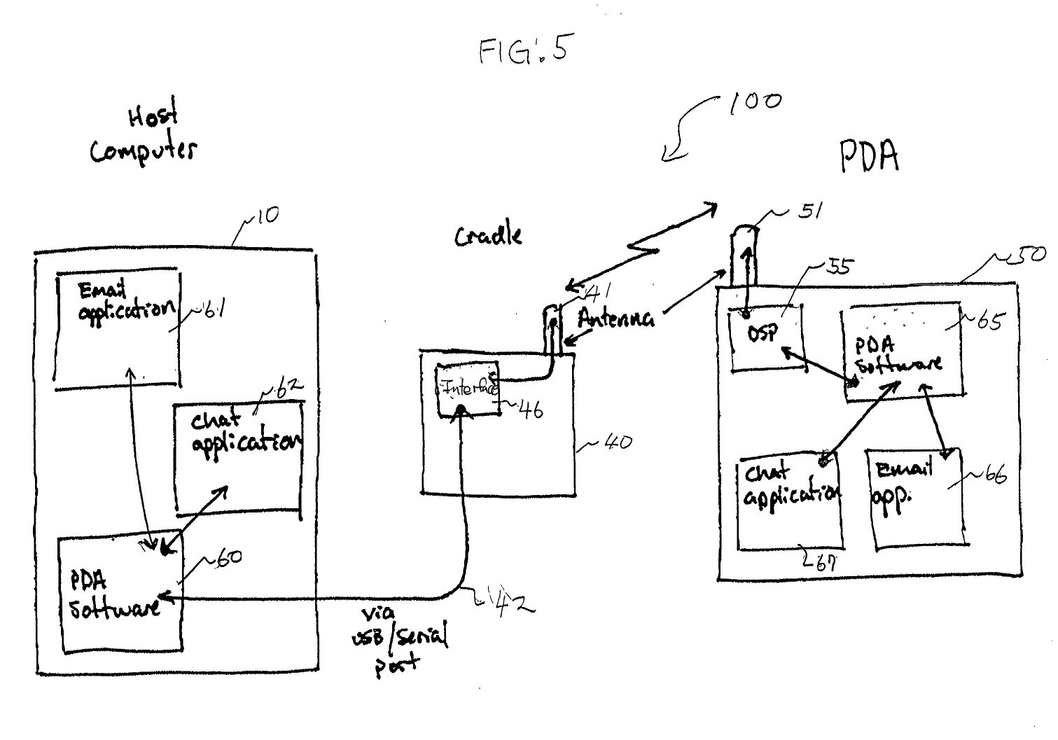

FIG. 5 shows a pictorial representation of cordless communication between the host computer 10 and the PDA 50 using cradle 40 in accordance with one embodiment of the present invention. It should be understood that certain components are shown in FIG. 5 for the purpose of explanation only, and that other components (not shown) may be disposed between the shown components.

Referring now to FIG. 5, at the initial set-up of the system 100, the host computer 10 is installed with PDA software 60 and other applications such as e-mail programs 61, chat programs 62, data synchronization programs, etc. These programs and applications may be stored in appropriate memory 28, 30 of the host computer 10. The PDA software 60 is a modified version of well known, conventional PDA software (e.g., Palm Desktop by Palm, Inc. for providing conventional PDA compatibility) which has been modified to allow cordless communication with the PDA 50 through the use of the cradle 40. The PDA software 60 will drive the cradle 40 to control signal transmission and reception to and from the antenna 41 of the cradle 40. =p Similarly to the host computer 10, the PDA 50 is also installed with PDA software 65 and applications such as e-mail programs 66, chat programs 67, data synchronization programs, etc. The PDA software 65 is a modified version of conventional PDA software (e.g., Palm OS by Palm, Inc. for providing typical PDA functions such as address books, notepads, appointment books, etc.) wherein the conventional PDA software is modified to allow cordless communication with the host computer 10 through the cradle 40. That is, the PDA software 65 controls transmission and reception of data to and from the antenna 51 of the PDA 50.

In accordance with the present invention, each of the host computer 10 and the PDA 50 is provided with a predetermined set of encryption and decryption keys. The encryption key is typically used to encode or encrypt data into a form unrecognizable by any other device unless the received data is decoded or decrypted using a decryption key. The decryption key is used to decode or decrypt the encrypted data. The host computer 10 and the PDA 50 transmit and receive data using the encryption and decryption keys, These encryption and decryption keys can be created using stored user information (e.g., name of the user of the PDA 50 or host computer 10) or any other information. The use of encryption and decryption keys in data communications is old and well known in the art.

The data transmission from the host computer 10 to the PDA 50 in accordance with one embodiment is as follows. When the host computer 10 is ready to transmit a message (e.g., a chat message, an e-mail, etc.) to the PDA 50, the host computer 10 transfers the message to the interface 46 of the cradle 40 through the wire connection 42. Under the control of the PDA software 60 installed in the host computer 10, the interface 46 may encrypt the message using the encryption key (which may be provided by the computer 10 or pre-stored in the cradle 40) and transfers the encrypted message signal to the transceiver 45. The transceiver 45 modulates the encrypted signal for radio transmission and the antenna 41 of the cradle 40 transmits the encrypted signal to the PDA 50.

The antenna 51 of the PDA 50 picks up the transmitted signal, assuming that the PDA 50 is within the cordless communication range of the cradle 40. It should be noted that as long as the PDA 50 is located within the antenna range of the cradle 40, the antenna 51 of PDA 50 can pick up the signal from the cradle 40. The antenna circuits 51 a of the PDA 50 demodulate the received signal and the DSP 55 converts the demodulated signal into digital form. Further, the DSP 55 decrypts the signal using the pre-stored decryption key to decipher the message, and directs the decrypted signal to other components (e.g., chip 56, processor 57, etc.) in the PDA 50 as needed according to the PDA software 65 or other applications installed in the PDA 50.

The data transmission from the PDA 50 to the host computer 10B is similar to the data transmission from the host computer 10 to the PDA 50 described herein above. Briefly, when the PDA 50 is ready to transmit a message (e.g., a chat message, an e-mail, etc.) to the host computer 10, the PDA 50 prepares the message under control of the PDA software 65. The DSP 55 encrypts the message using the encryption key and converts the encrypted signal into digital form. The antenna circuits 51 a modulate the processed signal from the DSP 55 and transmit it through the antenna 51.

The antenna 41 of the cradle 40 picks up the transmitted signal, assuming that the cradle 40 is within the cordless communication range of the PDA 50. The transceiver 45 of the cradle 40 demodulates the received signal, and the interface 46 decrypts the demodulated signal and transmits it to the user interface adapter 16 of the host computer 10 through the wire connection 42. The user interface adapter 16 processes the received signal and transfers it to the CPU 12 or other components of the computer 10 as needed according to the PDA software 60 or other applications

In one embodiment, 900 MHZ or 2.4 GHz spread spectrum (SS) technology, commonly used in cordless telephones, may further be employed in the present invention to provide enhanced security to cordless data communication between the host computer 10 and the PDA 50 through the cradle 40. In accordance with SS technology, the transmitter and receiver of data (which may be encrypted using the encryption key) may constantly change their transmission and reception frequencies on an on-going time basis, such that the data cannot be intercepted and easily deciphered by a third-party device. For instance, the host computer 10 may, through the cradle 40, transmit encrypted data to the PDA 50 at the frequency of 900 MHz, and then at 910 MHZ after 100 milliseconds later. At the same time, in accordance with SS technology, the antenna circuits 51a of the PDA 50 may be tuned to the frequency of 900 MHZ and then to 910 MHZ after 100 milliseconds later, so that the PDA 50 can receive the data transmitted from the host computer 10 even though the transmission frequency has changed. Since SS technology requires that both the transmitting and receiving device be in sync with each other with respect to transmission and reception frequencies at any given time, the security of cordless data transmission between the host computer 10 and the PDA 50 can be significantly improved.

Cordless communication offered by the cradle 40 can encompass any form of communication, including but not limited to, data synchronization, data transmission, data reception, data correction, etc. Thus the cradle 40 permits data synchronization between the host computer 10 and the PDA 50 without requiring the PDA 50 to be docked in the cradle 40. The data synchronization can also be provided in a conventional manner, i.e., by docking the PDA 50 which may also provide recharging of the PDA 50 for remote operations.

The principles of the present invention as applied in the system 100 can be implemented in a variety of different manners. For instance, a plurality of different encryption and decryption keys can be stored in the host computer 10 wherein these encryption and decryption keys have been assigned to different PDAs. This allows the host computer to selectively communicate with different PDAs using only the encryption and decryption keys that have been assigned to the targeted PDA. In the alternative, same encryption and decryption keys can be assigned to multiple PDAs. By this scheme, the host computer can communicate with multiple PDAs, simultaneously, using the same encryption and decryption keys.

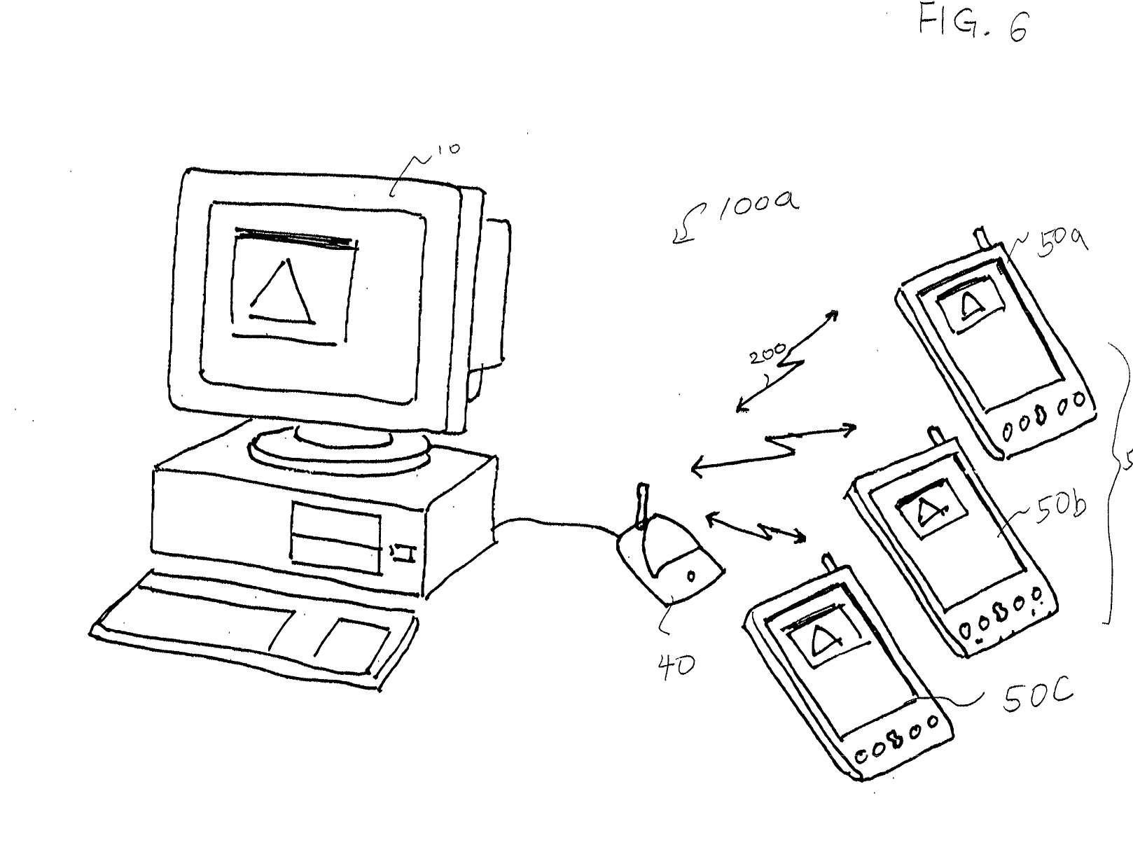

FIG. 6 shows a pictorial representation of a communication system 100a according to another embodiment of the present invention. The system 100a shown in FIG. 6 is identical to the system 100 shown in FIG. 1, except that it allows cordless communication among multiple PDAs 50a, 50b, 50c (collectively “50x”) through the cradle 40 and the host computer 10.

According to one implementation, the host computer 10 maintains a list of codes identifying different PDAs 50x, and each of the PDAs 50x maintain the same list in its memory, similar to an address book. If the user of the first PDA 50a desires to transmit a message to the second and/or third PDA 50b, 50c, the user prepares the message (e.g., using the stylus) and selects the targeted PDA 50b, 50c from the list, which causes the message and the codes associated with the targeted PDAs 50b, 50c to be transmitted to the cradle 40 through the antennas 41 and 51 according to the present invention. The cradle 40 processes and delivers the message and the codes to the host computer 10. The host computer 10 (e.g., CPU) is configured, e.g., via software to evaluate the codes in view of the stored list of codes, and to recognize that the message is meant for the targeted PDAs 50b, 50c based on this evaluation. The host computer 10 is also configured to retransmit the same message and the codes using the antenna 41 of the cradle 40 to the targeted PDA(s) 50b, 50c. The targeted PDAs 50b and 50c then receive the message and the codes since the codes identify that the message is meant for the targeted PDAs 50b and 50c, and process the message according to the present invention. In this manner, the cradle 40 can be utilized as an interface or a base station for providing cordless communication among multiple PDAs 50x.

Thus, according to the present invention, the PDAs can communicate with the host computer 100% of the time when they are in the operational range of the antenna of the cradle. This means that the user, either at work, job site, home, etc., can stay connected to his or her PC (host computer) constantly through the use of the cradle. The potential and applicability of the present invention is thus immense. For example, when the user enters important data into his or her PDA during a critical meeting, the user can immediately transfer the new data from the PDA to his PC by initiating cordless communication through the cradle according to the present invention. This reduces greatly the risk of losing key information. In addition, the user benefits from the convenience of transferring information from the PDA to his PC and vice versa at any time. Further, the user can create a synchronization schedule in the PDA for backing information from the PDA to the host computer at any time, so that backing information can be performed on a regular basis without having to dock the PDA in the cradle or without using any network services.

Moreover, the present invention allows the PDA to be used for real time interaction with any software installed on the user's PC or the like, rather than just storing and transferring data to the PC. There are numerous situations to which the present invention can be applied to improve the situations. The following are some examples of how the present invention may be utilized, but other examples are also possible.

In one example, a system administrator who monitors a server or other computer components, is given the PDA according to the present invention. The server may be connected to a separate PC which has been set up to perform cordless communication with the PDA through a cradle of the present invention, or the server (which in many cases is a PC itself) may be set up to perform the cordless communication of the present invention. Conventionally, if the server detects an error that requires a “yes” or “no” answer to continue operating, the server's PC or the server itself would display the error message on its screen and the server would stay down until the administrator see the error message and provides a response. In accordance with the present invention, however, the server's PC or the server itself can cordlessly transmit an error message to the PDA of the system administrator through the cradle. This message can be indicated in a variety of different ways, e.g., graphically or audibly. As long as the administrator is located within the cordless communication range of the cradle, the administrator can immediately receive the error message on the PDA and send a response from the PDA back to the server or server's PC through the cradle. The system can be programmed such that the server can automatically restart or correct its error based on the response from the administrator's PDA.

In another example, the user has an incoming AOL Instant Message from a chat buddy on the Internet being transmitted to his desktop which is turned on. However, the user is not at the desktop but is in the house or office doing something else. In this situation, conventionally the user will miss the chat message and his chat buddy would hang up since he will receive no response from the user. In accordance with the present invention, however, the PDA software installed in the desktop according to the present invention can be configured to automatically send an alert message to the user's PDA whenever an incoming chat message comes in. The user sees the alert message (which can be both visually and audibly communicated, e.g., by using a “chirping” sound). The user then can communicate with the chat buddy through his PDA using the cradle even though he is away from his desktop.

In still another example, different operational states of the PDA (namely, (1) out of range, (2) in range, not docked, and (3) in range, docked) which exist due to the present invention can be utilized to configure a chat program installed on the host computer and the PDA. For example, if the PDA is in the first state where the PDA is out of range of the cradle, and if a chat message from an external chatter (e.g., Jay Jones) to a receiver (e.g., Sue Jones) comes into Sue's PC, the chat program on Sue's PC can be configured to automatically return a message to the external chatter indicating that the receiver is not within the reachable range, e.g., “Sue Jones is offline.” If the PDA is in the second state where the PDA is in range and not docked in the cradle, and if the chat message is received by Sue's PC, the chat program can be configured to transmit a message to Sue's PDA, e.g., “Jay Jones is attempting to contact you for a chat, would you like to chat with Jay Jones?” If Sue's response is yes and is input to Sue's PDA, the PDA communicates the response to Sue's PC and the PC directs Jay's chat message to Sue's PDA via the cradle, and the chatting begins. If the PDA is in the third state where it is in range but docked in the cradle, and if the chat message comes into Sue's PC, the chat program on Sue's PC can be configured to automatically return a message to the external chatter indicating that the receiver is not available, e.g., “Sue Jones is not available.” The PC can be configured to beep to indicate an arrival of a chat message and can be configured to display the chat message in the standard PC chat window.

In different examples, computer service technicians could use the PDA and the cradle of the present invention to download troubleshooting information and schematics from the host computer while they are working on computers with problems. The home users can use the PDA of the present invention to communicate with their computers and applications such as IBM Home Director, via the cradle of the present invention, so as to control their appliances from anywhere in the home.

Although the present invention has been described with respect to a specific preferred embodiment thereof, various changes and modifications may be suggested to one skilled in the art. It is intended that the present invention encompass such changes and modifications as they fall within the scope of the appended claims.

We claim:

1. A docking device capable of synchronizing a host computer and a portable communications device when the communications device is docked in the docking device, wherein the docking device provides cordless communication between the portable communications device and the host computer without docking of the portable communications device in the docking device.

2. The docking device of claim 1, wherein the docking device comprises:
an antenna for transmitting and receiving radio signals to and from the portable communications device; and
a signal processor, coupled to the antenna, for processing the radio signals to provide the cordless communication.

3. The docking device of claim 2, wherein the antenna has an operational range of about 100 to 300 feet.

4. The docking device of claim 2, wherein the signal processor includes a transceiver and an interface module for communicating with the host computer.

5. The docking device of claim 2, further comprising:
a connection for physically and electrically connecting the docking device to the host computer, wherein the radio signals processed by the signal processor are delivered to the host computer through the connection.

6. The docking device of claim 2, wherein the signal processor processes the radio signals using predetermined encryption and decryption keys.

7. The docking device of claim 6, wherein the predetermined encryption and decryption keys are same as those used in the portable communications device.

8. The docking device of claim 2, wherein data synchronization between the host computer and the portable communications device is performed using the antenna without the portable communications device docked in the docking device.

9. The docking device of claim 1, wherein the portable communications device is a personal digital assistant (PDA) device.

10. The docking device of claim 1, wherein the portable communications device is a telephone providing personal digital assistant (PDA) functions.

11. A personal digital assistant (PDA) device for use with a host computer and a docking device connected to the host computer, the docking device capable of synchronizing the host computer and the PDA device when the PDA device is docked in the docking device, the docking device including an antenna for cordless communication, the PDA device comprising:
an antenna for cordlessly communicating with the antenna of the docking device; and
a signal processor, coupled to the antenna of the PDA device, for processing signals received from the antenna, wherein cordless communication is established between the PDA device and the host computer through the antenna of the PDA device and the antenna of the docking device.

12. The PDA device of claim 11, wherein the antenna of the PDA device has an operational range of about 100 to 300 feet.

13. The PDA device of claim 11, wherein the signal processor processes the signals using predetermined encryption and decryption keys.

14. The PDA device of claim 13, wherein the predetermined encryption and decryption keys are same as those used in the docking device.

15. The PDA device of claim 11, wherein data synchronization between the host computer and the PDA device is performed using the antennas without docking of the PDA device in the docking device.

16. The PDA device of claim 11, wherein the PDA device provides telephone functions.

17. A computer for establishing cordless communication with at least one personal digital assistant (PDA) using a docking device, the docking device capable of synchronizing the computer and the PDA when the PDA is docked in the docking device, the computer comprising:
a processor for providing to the docking device at least one set of security keys to be used in the cordless communication with the PDA; and
an interface, coupled to the processor, for interfacing communication between the processor and the docking device, wherein the cordless communication is established between the computer and the PDA through the docking device without docking of the PDA in the docking device.

18. The computer of claim 17, wherein the processor maintains a list of different sets of security keys assigned to a plurality of PDAs, and selectively provides to the docking device one or more sets of the security keys from the list, whereby the computer can selectively communicate with the PDAs.

19. The computer of claim 17, wherein the processor maintains one set of security keys commonly assigned to a plurality of PDAs, and provides the set of security keys to the docking device, whereby the computer can simultaneously communicate with all of the PDAs.

20. The computer of claim 17, wherein the computer maintains a list of PDA identifiers for identifying different PDAs, and uses the list to relay any communication from one PDA to another PDA through the docking device.

21. A communication system for establishing cordless communication in a computing environment, the system comprising:
a host computer;
at least one portable communications device having an antenna for cordless communication with the host computer;
a docking device coupled to the host computer and having an antenna for communicating with the antenna of the portable communications device, whereby cordless communication is established between the host computer and the portable communications device through the docking device without docking of the portable communications device in the docking device.

22. The system of claim 21, wherein at least one of the antenna of the docking device and the antenna of the portable communications device has an operational range of about 100 to 300 feet.

23. The system of claim 21, wherein the docking device further includes a transceiver and an interface module for communicating with the host computer.

24. The system of claim 23, wherein the docking device further includes a connection for physically and electrically connecting the docking device to the host computer.

25. The system of claim 23, wherein the interface module of the docking device performs data transmission and data reception using predetermined encryption and decryption keys.

26. The system of claim 21, wherein the portable communications device processes signals to and from the antenna of the docking device using predetermined encryption and decryption keys.

27. The system of claim 26, wherein the docking device processes signals to and from the antenna of the portable communications device using the predetermined encryption and decryption keys.

28. The system of claim 26, wherein the predetermined encryption and decryption keys include user data.

29. The system of claim 21, wherein the portable communications device is a personal digital assistant (PDA).

30. The system of claim 21, wherein the portable communications device is a telephone providing personal digital assistant (PDA) functions.

31. The system of claim 21, wherein the docking device synchronizes the host computer and the portable communications device when the portable communications is docked in the docking device.

32. The system of claim 21, wherein the host computer comprises:
a processor for providing to the docking device at least one set of security keys to be used in the cordless communication; and
an interface, coupled to the processor, for interfacing communication between the processor and the docking device.

33. The system of claim 21, wherein the computer maintains a list of different sets of security keys assigned to a plurality of portable communications devices, and selectively provides to the docking device one or more sets of the security keys from the list, whereby the computer can selectively communicate with the portable communications devices.

34. The system of claim 21, wherein the computer maintains one set of security keys commonly assigned to a plurality of portable communications devices, and provides the set of security keys to the docking device, whereby the computer can simultaneously communicate with all of the portable communications devices.

35. The system of claim 29, wherein the computer maintains a list of PDA identifiers for identifying different PDAs, and uses the list to relay any communication from one PDA to another PDA through the docking device.

36. A method for establishing cordless communication between a host computer and at least one portable communications device using a docking device, wherein the docking device is connected to the host computer and capable of synchronizing the portable communications device and the host computer when the communications device is docked in the docking device, the method comprising:
communicating a signal between the host computer and the portable communications device through the docking device without docking of the portable communications device in the docking device.

37. The method of claim 36, wherein the docking device includes a first antenna and the portable communications device includes a second antenna, and wherein the communicating step communicates the signal through the first and second antennas.

38. The method of claim 36, wherein the communicating step communicates the signal using predetermined security keys.

39. The method of claim 36, wherein the communicating step communicates the signal using Spread Spectrum technologies.

40. The method of claim 36, wherein the portable communications device is a personal digital assistant (PDA).

41. The method of claim 40, wherein the communicating step communicates the signal from the host computer to a plurality of PDAs, simultaneously, using a set of predetermined security keys commonly assigned to the PDAs.

42. The method of claim 40, wherein the communicating step selectively communicates the signal from the host computer to a plurality of PDAs using different sets of predetermined security keys assigned to the PDAs.

43. The method of claim 40, wherein the PDA provides telephone functions.

44. The method of claim 36, further comprising:
relaying communication from one portable communications device to another portable communications device using a list of device identifiers for identifying different portable communications devices.

45. A computer program product embodied on computer readable media readable by a computing device, the product comprising:
computer-readable program code means for providing personal digital assistant (PDA) functions to a portable communications device; and
computer-readable program code means for configuring a host computer and the portable communications device to perform cordless communication each other through a docking device without requiring docking of the portable communications device in the docking device.

46. The product of claim 45, further comprising:
computer-readable program code means for generating a set of security keys to be used in the cordless communication.

47. The product of claim 46, further comprising:
computer-readable program code means for providing data synchronization between the host computer and the portable communications device when the communications device is docked in the docking device.
